(19) United States
(12) Patent Application Publication
(10) Pub. No.: US 2024/0165982 A1
(43) Pub. Date: May 23, 2024

(54) SUBLIMATION TRANSFER PRINTING PAPER

(71) Applicant: SAPPI NETHERLANDS SERVICES B.V., Maastricht (NL)

(72) Inventors: Bernardo SEMADENI, Carmignano di Brenta (IT); Alberto FUSAR, Carmignano di Brenta (IT)

(21) Appl. No.: 18/552,045

(22) PCT Filed: Apr. 23, 2021
(86) PCT No.: PCT/EP2021/060701

§ 371 Date: Sep. 22, 2023

(51) Int. Cl. B41M 5/035; B41M 5/52

(52) U.S. Cl. CPC B41M 5/0356; B41M 5/0358; B41M 5/5281; B41M 2205/36

(57) ABSTRACT

A sublimation transfer paper for sublimation transfer printing with water-based dye sublimation inks, comprising a fibrous substrate and at least one printable transfer layer, characterized in that the printable transfer layer comprises at least one polyurethane.

### TECHNICAL FIELD

The present invention relates to sublimation transfer paper for transfer printing with water-based dye sublimation inks, methods of manufacturing and using such sublimation transfer paper.

### PRIOR ART

Sublimation transfer printing is a process by which a transfer image, which is printed on a transfer paper, is transferred to a final substrate such as for example a textile, by closely contacting the printed transfer paper with a surface of the final substrate and heating the printed transfer paper to a temperature at which the ink forming the transfer image sublimates and allowing the ink sublimate to condense on the final substrate and forming an image thereon.

Therefore, sublimation transfer printing requires the use of specially designed thermal sublimation inks, so-called “sub inks”.

Sublimation transfer printing can be used to coat a wide variety of substrates such as for example leather substrates, synthetic textile substrates such as clothes, shoes, and flags or banners, hard substrates such as skis, snowboards, plates, mugs and the like.

With the advent of digital printing, especially digital inkjet printing, it has become possible to individualize images that are printed on such substrates and/or to produce small batches of printed substrates without the expenditure associated with more traditional printing methods such as flexographic or off-set printing.

However, sublimation transfer printing suffers from well-known issues, one of which is the occurrence of “ghosting”, which is a phenomenon in which the image, after having been transferred to the substrate, appears twice, with one copy having the intended position and color intensity and the other copy having a slightly shifted position and a lesser color intensity.

Ghosting occurs mostly when the transfer paper and the substrate are separated after the sublimation transfer step, because of the residual heat and relative motion of the transfer paper and substrate. As a result, prints having ghosting defects must be discarded.

Ghosting thus results in a certain proportion of production waste, which leads to higher overall production costs.

As one possible solution to mitigate ghosting problems, increasing the tackiness of the transfer paper has been proposed.

The sublimation transfer papers used so far in the industry have transfer layers that are based on PVOH that, besides from delivering sub-optimal print quality in sublimation transfer printing, suffer from low and varying tackiness.

In order to control the level and fluctuation of tackiness, it has become a practice to use tack sprays that can be applied to the mostly PVOH-based transfer layer of current sublimation transfer papers. Applying such sprays however increases material costs, complicates handling, and increases production time, and thus also results in a higher cost of production.

There exists thus a desire to provide a solution that allows to reduce the occurrence of ghosting in sublimation transfer printing without negative effects on production time, material cost or handling time.

No dye sublimation papers are available on the market being able to assure good tackiness and excellent printability, in terms of image quality and fast ink drying, as well as good transfer properties with industrial inks used on industrial inkjet printers.

### SUMMARY OF THE INVENTION

The present invention provides a sublimation transfer paper for transfer printing with water-based dye sublimation inks, that allows for a reduction of ghosting during transfer printing by exhibiting increased and/or constant tackiness, while at the same time also having excellent drying speed, ink load capacity, ink release and image quality.

The present sublimation transfer paper for transfer printing with water-based dye sublimation inks in particular leads to an increase in tackiness during transfer printing especially in the area of the sublimation transfer paper that is printed with the water-based dye sublimation inks, because, without wishing to be held to a particular theory, the glycols in the water-based dye sublimation inks interact with the unique components of the transfer layer.

It is an object of the present invention to provide a sublimation transfer paper for sublimation transfer printing with water-based dye sublimation inks, comprising a fibrous substrate and at least one printable (or printed) transfer layer at least on one side of the substrate, characterized in that the printable (or printed) transfer layer comprises at least one polyurethane.

A printable (or printed) transfer layer comprising at least one polyurethane of the, in contrast to known printable transfer layers that do not include polyurethane, provides the desired amount of tackiness during sublimation transfer printing with water-based dye sublimation inks.

The desired amount of tackiness eliminates the risk of ghosting defects during sublimation transfer printing.

Further embodiments of the invention are laid down in the dependent claims.

### DESCRIPTION OF PREFERRED EMBODIMENTS

It is an object of the present invention to provide a sublimation transfer paper for sublimation transfer printing with water-based dye sublimation inks, comprising a fibrous substrate and at least one printable (or printed) transfer layer on one side, characterized in that the printable transfer layer comprises at least one polyurethane.

The water-based dye sublimation inks that are suitable for use in the context of sublimation transfer printing using the sublimation transfer paper of the present invention are liquid inks. In particular, the water-based dye sublimation inks that are suitable for use in the context of sublimation transfer printing using the sublimation transfer paper of the present invention are inks comprising further co-solvents having a boiling point that is higher than the boiling point of water, such as for example glycols.

Sublimation transfer papers differ from other printable papers, such as newsprint, magazine or graphic paper in that they are optimized to hold inks only transiently, in opposition to newsprint, magazine or graphic paper which are designed to fixate the inks permanently. Thus, the interaction between the components of the printable transfer layer in sublimation transfer papers must be such that the water-based dye sublimation ink is released from the printed transfer layer during heating of the sublimation transfer paper, in order to form an image on a surface of the object to be printed.

In a preferred embodiment, the water-based dye sublimation inks that are suitable for use in the context of sublimation transfer printing using the sublimation transfer paper of the present invention include one or more glycols chosen among ethylene glycol, propane-1,2-diol, propane-1,3-diol, 1,2-butanediol, 1,3-butanediol, 1,4-butanediol, and 2,3-butanediol, or other appropriate glycols.

It is noted that water-based dye sublimation inks that are suitable for use in the context of sublimation transfer printing using the sublimation transfer paper of the present invention are mainly used in the context of digital inkjet printing, mostly on industrial scale applications, and have led to variable tackiness during sublimation transfer printing when using conventional sublimation transfer papers based on PVOH.

In a preferred embodiment, the water-based dye sublimation inks that are suitable for use in the context of sublimation transfer printing using the sublimation transfer paper of the present invention are water-based dye sublimation inkjet inks which are suitable to be used in industrial digital inkjet printers, but not in consumer digital inkjet printers.

The sublimation transfer paper for sublimation transfer printing according to the present invention may have a grammage of from 40 to about 130 gsm, and preferably from 60 to 100 gsm.

The sublimation transfer paper for sublimation transfer printing according to the present invention comprises a fibrous substrate, preferably a paper or paperboard substrate. Suitable paper or paperboard are, without limitation, sulphite paper, kraft paper, which may be bleached or unbleached, but preferably bleached. It is understood that the function of the fibrous substrate is mainly as mechanical support for the printable transfer layer.

In a preferred embodiment of the sublimation transfer paper for sublimation transfer printing with water-based dye sublimation inks according to the present invention, the fibrous substrate comprises an internal sizing agent based on treated colophony, alkyl succinic anhydride (ASA), or alkyl ketene dimer (AKD). The sized fibrous substrate affects the ability of the fibrous substrate paper to absorb the printable transfer layer coating during application of the coating onto the fibrous substrate. After the printing of the transfer layer, the sized fibrous substrate affects the absorption of the solvent, i.e. water and the co-solvents, i.e. glycols, of the water-based dye sublimation inks by the cellulose fibres.

In a preferred embodiment of the sublimation transfer paper for sublimation transfer printing with water-based dye sublimation inks according to the present invention, the fibrous substrate has a grammage of from 30 to 120 g/m².

In a preferred embodiment of the sublimation transfer paper for sublimation transfer printing with water-based dye sublimation inks according to the present invention, the tacky side of the transfer paper, measured before printing, has a COBB value (20 s) comprised between 10 and 40 g/m² according to ISO 535.

In a preferred embodiment of the sublimation transfer paper for sublimation transfer printing with water-based dye sublimation inks according to the present invention, the fibrous substrate, and preferably the sublimation transfer paper, has a porosity more than 4.000 s Gurley, according to TAPPI T460. A high porosity value means that the water-based dye sublimation inks, when in the gas phase during sublimation transfer printing, are hindered to move through the fibrous substrate or the sublimation transfer paper, thereby maximizing the ink transfer onto the object to be printed.

The sublimation transfer paper for sublimation transfer printing according to the present invention comprises at least one printable (or printed) transfer layer, characterized in that the printable transfer layer comprises at least one polyurethane.

It has been found during sublimation transfer printing, that the tackiness between the printed transfer layer and the object to be printed, when using conventional sublimation transfer papers having a CMC/PVOH-based printable transfer layer is not constant and that consequently the force needed for peeling the spent sublimation transfer paper off the object to be printed is also not constant. Thus, variations in the amount of tackiness can lead to printing defects such as ghosting or even to the rupture of the object to be printed, especially when it is a delicate textile. In particular, the variations leading to lower tackiness cause a higher risk of ghosting, whereas the variations leading to higher tackiness cause a higher risk of damaging (e.g. ripping) the textiles.

When the printable transfer layer, as is the case in the present invention, comprises at least one polyurethane, the tackiness between the printed transfer layer and the object to be printed can be adjusted in the sense that the magnitude of the tackiness can be tailored by varying the amount of the polyurethane and in the sense that the variation of tackiness can be reduced. In general, an increase in the amount of polyurethane leads to an increase in tackiness.

During the formulation of the printable transfer layer coating, the polyurethane in the printable transfer layer may be added in the form of an emulsion, specifically a latex, in particular an aqueous emulsion, specifically an aqueous latex.

In the printable transfer layer, the polyurethane is preferably comprised in an amount of at least 5 weight percent, and more preferably in an amount of from 5 to 50 weight percent, based on the total dry weight of the printable transfer layer.

The sublimation transfer paper for sublimation transfer printing according to the present invention comprises a printable transfer layer. The printable transfer layer may be located on one side or even both sides of the sublimation transfer paper, and preferably, the printable transfer layer is comprised on one side, i.e. only that side, of the sublimation transfer paper and/or the fibrous substrate. It is noted that the printable transfer layer may be directly adjacent to the fibrous substrate or that it may be adjacent to an intermediate layer that is positioned adjacent to the fibrous substrate.

In an embodiment of the sublimation transfer paper for sublimation transfer printing with water-based dye sublimation inks according to the present invention, the printable transfer layer may cover essentially the entire surface of one side of the sublimation transfer paper, or both, as the case may be.

In an alternative embodiment of the sublimation transfer paper for sublimation transfer printing with water-based dye sublimation inks according to the present invention, the printable transfer layer may cover only a part of the entire surface of one side of the sublimation transfer paper, or of both sides, as the case may be.

In a preferred embodiment of the sublimation transfer paper for sublimation transfer printing with water-based dye sublimation inks according to the present invention, in the printable transfer layer, the polyurethane is an aliphatic polyurethane. When using an aliphatic polyurethane, it has been found that a yellowing of the printable transfer layer can be avoided even when the sublimation transfer paper is stored for a long time and that thus the shelf-life can be extended.

In a preferred embodiment of the sublimation transfer paper for sublimation transfer printing with water-based dye sublimation inks according to the present invention, the printable transfer layer comprises at least one silica. During the formulation of the printable transfer layer coating, the at least one silica in the printable transfer layer may be added in the form of a powder or a slurry.

In a preferred embodiment of the sublimation transfer paper for sublimation transfer printing with water-based dye sublimation inks according to the present invention, the silica is a hydrophilic silica. When silica is included in the printable transfer layer, the ink uptake speed of the printable transfer layer can be increased because the silica quickly absorbs water as well as glycols, which allows for faster printing of the printable transfer layer.

In a preferred embodiment of the sublimation transfer paper for sublimation transfer printing with water-based dye sublimation inks according to the present invention, the silica is preferably comprised in an amount of at least 5 weight percent, and more preferably in an amount of from 5 to 20 weight percent, based on the total dry weight of the printable transfer layer.

In a preferred embodiment of the sublimation transfer paper for sublimation transfer printing with water-based dye sublimation inks according to the present invention, the printable transfer layer has a coat weight of 2 to 12 g/m². It is noted that the amount of water-based dye sublimation ink that can be held in the printable transfer layer can be influenced by the coat weight of the printable transfer layer. A higher coat weight means that a higher amount of water-based dye sublimation ink can be held in the printable transfer layer.

In a preferred embodiment of the sublimation transfer paper for sublimation transfer printing with water-based dye sublimation inks according to the present invention, the polyurethane has a glass transition temperature T_{g} of, for example, in the range of 40 to 150° C., when measured via differential scanning calorimetry (DSC). The upper boundary, which corresponds to a temperature below the sublimation temperature of water-based dye sublimation inks that are currently available commercially in textile applications, ensures that the tackiness needed to avoid defects on the object to be printed develops prior to, or at least during, the actual sublimation transfer of the water-based dye sublimation inks from the sublimation transfer paper to the object. Likewise, the lower boundary, which corresponds to a temperature that is seldom reached during storage and handling of the sublimation transfer paper prior to the actual sublimation transfer printing, ensures that the sublimation transfer paper does not develop tackiness during storage and/or handling that would complicate storage and/or handling. In some cases, paper machines run papers at temperatures above 80 or 90° C., and so, in another embodiment of the sublimation transfer paper for sublimation transfer printing with water-based dye sublimation inks according to the present invention, the polyurethane has a glass transition temperature T_{g} of, for example, in the range of 80 to 150° C., or of 90 to 150° C. In general, it is understood that the glass transition temperature T_{g} of the polyurethane in the transfer layer should be chosen such that the glass transition temperature T_{g} of the polyurethane in the transfer layer is below the temperature(s) at which the sublimation transfer printing is carried out to ensure tackiness during the actual sublimation transfer of the water-based dye sublimation inks and/or above temperatures encountered prior to sublimation transfer printing.

In a preferred embodiment of the sublimation transfer paper for sublimation transfer printing with water-based dye sublimation inks according to the present invention, the printable (or printed) transfer layer comprises a mixture of two or more polyurethanes preferably having different glass transition temperatures T_{g}. The inclusion of a mixture of two or more polyurethanes allows an extension of the range of temperature at which tackiness develops.

In a preferred embodiment of the sublimation transfer paper for sublimation transfer printing with water-based dye sublimation inks according to the present invention, the printable transfer layer further comprises a natural polysaccharide or a derivative thereof. Examples of natural polysaccharides that may be used in the printable transfer layer are gums such as guar gum, or starch. Examples of derivatives of natural polysaccharides that may be used in the printable transfer layer are carboxymethyl cellulose or modified starch.

In a preferred embodiment of the sublimation transfer paper for sublimation transfer printing with water-based dye sublimation inks according to the present invention, the natural polysaccharide or a derivative thereof is carboxymethyl cellulose.

In a preferred embodiment of the sublimation transfer paper for sublimation transfer printing with water-based dye sublimation inks according to the present invention, the natural polysaccharide or a derivative thereof, and in particular the carboxymethyl cellulose is chosen such as to display a viscosity within the range of 1.000 and 10.000 mPa's when measured by Brookfield viscosimetry with a number 4 spindle at 20 rpm and 20° C.

In a preferred embodiment of the sublimation transfer paper for sublimation transfer printing with water-based dye sublimation inks according to the present invention, for the natural polysaccharide or a derivative thereof, and in particular for the carboxymethyl cellulose, the above viscosity properties can be reached via a treatment with hydrolytic enzymes such as for example endoglucanases, which results in a shortening of the molecules and thus a change in rheological properties. Furthermore, it has been found that in the case where the natural polysaccharide or a derivative thereof, and in particular the carboxymethyl cellulose, is treated with hydrolytic enzymes, the development of odours can be avoided during sublimation transfer printing. While the development of such odours is not known to pose any health issues, it is nonetheless a nuisance in closed rooms or rooms with little ventilation and the reduction of the odour emission represents a significant advantage for personnel operating the sublimation transfer printing devices.

It is noted that the term “natural polysaccharide or a derivative thereof”, and “carboxymethyl cellulose” refers also to the salts thereof as well where not otherwise provided, such as for example sodium salts. For example, carboxymethyl cellulose refers to both carboxymethyl cellulose and a salt of carboxymethyl cellulose such as for example sodium carboxymethyl cellulose.

In the printable transfer layer, the natural polysaccharide or a derivative thereof is preferably comprised in an amount of at least 5 weight percent, more preferably in an amount of 50 weight percent and more preferably in an amount of from 50 to 70 weight percent, or 20 to 40% weight percent, based on the total dry weight of the printable transfer layer.

In a preferred embodiment of the sublimation transfer paper for sublimation transfer printing with water-based dye sublimation inks according to the present invention, the natural polysaccharide or derivative thereof is a sodium salt of carboxymethylcellulose (CMC) and/or the weight ratio between the polyurethane and the natural polysaccharide or derivative thereof is of from 1:10 to 5:10.

The natural polysaccharide or derivative thereof provides, among others, a storage capacity for water-based dye sublimation inks within the printable transfer layer. In consequence, an increased ink storage capacity can be achieved by increasing the content of the natural polysaccharide and decreasing the content of polyurethane, which then also leads to a decreased tackiness during sublimation transfer printing.

Thus, if an increased ink storage capacity is desired, while preserving the same level of tackiness, the coat weight of the printable transfer layer can be increased. Conversely, if an increased tackiness is desired, while preserving the same level of ink storage capacity, the amount of polyurethane in of the printable transfer layer can be increased.

It follows that in the sublimation transfer paper for sublimation transfer printing with water-based dye sublimation inks, the printable transfer layer allows to accommodate tackiness and ink storage capacity requirements without having to sacrifice one for the other.

In a preferred embodiment of the sublimation transfer paper for sublimation transfer printing with water-based dye sublimation inks according to the present invention, the sublimation transfer paper further comprises an anti-curling layer on the side opposite the side of the printable transfer layer, and wherein the anti-curling layer has approximately the same coat weight as the printable transfer layer. The anti-curling layer can itself be printed or not, and serves to avoid curling of the sublimation transfer paper during the sublimation transfer printing. The anti-curling layer may also include pressure sensitive adhesive (PSA) to enhance the sticking of the anti-curling layer to the platen of a heat press during sublimation transfer printing.

In a preferred embodiment of the sublimation transfer paper for sublimation transfer printing with water-based dye sublimation inks according to the present invention, the at least one printable transfer layer is printed with a water-based dye sublimation ink. The sublimation transfer paper for sublimation transfer printing with water-based dye sublimation inks according to the present invention may thus be printed in advance and stored until such time the sublimation transfer printing is carried out or it may be stored while unprinted until such time a sublimation transfer printing is to be carried out “on-demand”. This, the sublimation transfer paper allows for more flexibility due to its advantageous shelf life in either printed or unprinted state.

It is further an object of the present invention to provide a method of transfer printing with water-based dye sublimation inks, comprising the steps of, in this order,
providing a sublimation transfer paper according to the above,
printing a transfer image on a printable transfer layer of the sublimation transfer paper with one or more water-based dye sublimation inks,
contacting the transfer image on the printed printable transfer layer of the sublimation transfer paper with an image receiving surface of an object to be printed,
heating the sublimation transfer paper until the transfer image is transferred to the image receiving surface of an object to be printed. It is noted that the temperature needed for the transfer image to be transferred to the image receiving surface of an object to be printed is generally a temperature that is at least, and preferably above, the glass transition temperature T_{g} of the polyurethane comprised in the printable transfer layer of the sublimation transfer paper.

The step of printing a transfer image on a printable transfer layer of the sublimation transfer paper with one or more water-based dye sublimation inks may be carried out using an ink-jet printer, and preferably an industrial ink-jet printer. Ink-jet printers, in contrast to printers requiring an image plate such as flexo printing, are more flexible with respect to the image to be printed on the printable transfer layer in that each image may in principle be different from the previous one. For that reason, in small to medium printing jobs, an ink-jet printer is preferably used because of its cost efficiency and ability to be customize the printing image virtually “on-the-fly”.

The step of contacting the transfer image on the printed printable transfer layer of the sublimation transfer paper with an image receiving surface of an object to be printed may be carried out in a heat press, essentially consisting of two opposite platen, of which one (usually the top platen) can be controllably heated to a set temperature and pressed down at a set pressure onto the opposite platen with the printed sublimation transfer paper and image receiving surface of the object to be ultimately printed sandwiched between the platen. In the clamped-down configuration, the pressure exerted onto the printed sublimation transfer paper and image receiving surface of the object to be ultimately printed sandwiched between the two platen ensures that the printed sublimation transfer paper is in static contact with respect to the image receiving surface of the object to be ultimately printed while the sublimation transfer printing process is underway. It is understood that the platen may cylindrical, planar or any other form adapted to the form of the object to be printed.

The step of heating the sublimation transfer paper until the transfer image is transferred to the image receiving surface of an object to be printed is carried out on the heat press by controllably heating a platen to a set temperature and pressing down at a set pressure onto the opposite platen and the printed sublimation transfer paper and the object to be printed. Suitable temperatures that achieve the sublimation and transfer of the water-based dye sublimation inks range from about 150° ° C. to about 250° C. and suitable pressures range from about 1 bar to about 5 bar. An example of a temperature that may be used is 180° C. or above, in the case of synthetic textiles, with the proviso that the temperature does not exceed the melting temperature of the synthetic textile such for example a polyester textile.

In general, when using a synthetic textile, the temperature that is used should be at least 10° C. below the melting temperature of the synthetic textile. For instance, polyesters such as PET have a melting point beyond about 255° C., and thus the temperature that may be preferably used during sublimation transfer printing is in the range of 190 to 240° C., at which temperature both the polyurethane develops a desired tackiness and also the sublimation ink sublimates.

In an embodiment of the method of transfer printing with water-based dye sublimation inks according to the present invention, the object is a textile, in particular a synthetic textile such as a polyester textile. In a preferred embodiment, the textile is an elastic textile, specifically a technical textile, such as for sports, outdoor activities or other special applications (presenting special properties such as water repellence, breathability, wicking properties, antimicrobial characteristics, etc.)

In an embodiment of the method of transfer printing with water-based dye sublimation inks according to the present invention, the object is a wintersport equipment such as a ski, snowboard or a surface thereof, or a boardsport equipment such as a wakeboard, waveboard, skateboard or a surfboard or a surface thereof, or any other sport equipment.

In an embodiment of the method of transfer printing with water-based dye sublimation inks according to the present invention, the object is a dishware such as for example plates, mugs, cups or bowls, which may preferably made of ceramic, resin, wood or any suitable material.

It is further an object of the present invention to provide a method of producing a sublimation transfer paper according to the above, comprising the steps of:
providing a fibrous substrate as described above,
applying a layer of printable transfer layer coating comprising a polyurethane emulsion or latex, preferably an aliphatic polyurethane emulsion or latex, to at least one side of the fibrous substrate, at a dry coat weight of 2 to 12 g/m²,
drying the coating.

In the context of the method of producing a sublimation transfer paper according to the above, the term “drying” refers to the removal of water until a final humidity of less than 7%, or a humidity of between 7% and 4%, preferably of about 5.5%, or between 5% and 6%, is reached.

In an embodiment of the method of producing a sublimation transfer paper as mentioned above, the polyurethane emulsion or latex is an aqueous polyurethane emulsion or latex.

In an embodiment of the method of producing a sublimation transfer paper as mentioned above, the aqueous coating composition is applied with a film press applicator, a stiff blade applicator, a bent blade applicator, a metering rod applicator, a smooth rod applicator, or a spray coating applicator, or other equivalent industrial methods.

It is further an object of the present invention to provide a use of a sublimation transfer paper according to the above in sublimation transfer printing with water-based dye sublimation inks.

### LIST OF REFERENCE SIGNS

none

1. A sublimation transfer paper for sublimation transfer printing with water-based dye sublimation inks, comprising a fibrous substrate and at least one printable transfer layer, wherein the at least one printable transfer layer comprises at least one polyurethane.

2. The sublimation transfer paper according to claim 1, wherein the at least one printable transfer layer comprises at least one silica.

3. The sublimation transfer paper according to claim 1, wherein the at least one printable transfer layer comprises at least one aliphatic polyurethane.

4. The sublimation transfer paper according to claim 2, wherein the at least one silica is a hydrophilic silica.

5. The sublimation transfer paper according to claim 1, wherein the at least one printable transfer layer comprises the at least one polyurethane in an amount of 5 to 50 weight percent, based on the total dry weight of the at least one printable transfer layer.

6. The sublimation transfer paper according to claim 1, wherein the at least one printable transfer layer has a coat weight of 2 to 12 g/m².

7. The sublimation transfer paper according to claim 1, wherein the at least one polyurethane has a glass transition temperature T_{g} in the range of 40 to 150° C., when measured according to ISO 11357-2.

8. The sublimation transfer paper according to claim 1, wherein the at least one printable transfer layer further comprises a natural polysaccharide or derivative thereof.

9. The sublimation transfer paper according to claim 1, wherein the sublimation transfer paper further comprises an anti-curling layer on the side opposite the side of the at least one printable transfer layer, and wherein the anti-curling layer has approximately the same coat weight as the at least one printable transfer layer.

10. The sublimation transfer paper according to claim 1, wherein the fibrous substrate comprises an internal sizing agent based on treated colophony, alkyl succinic anhydride (ASA), or alkyl ketene dimer (AKD).

11. The sublimation transfer paper according to claim 1, wherein the at least one printable transfer layer is printed with a water-based dye sublimation ink.

12. A method of transfer printing with water-based dye sublimation inks, comprising the steps of, in this order,
providing the sublimation transfer paper according to claim 1, printing a transfer image on the at least one printable transfer layer of the sublimation transfer paper with one or more water-based dye sublimation inks, contacting the transfer image on the printed at least one printable transfer layer of the sublimation transfer paper with an image receiving surface of an object to be printed,
heating the sublimation transfer paper until the transfer image is transferred to the image receiving surface of the object to be printed.

13. The method of transfer printing according to claim 12, wherein the object is a textile.

14. A method of producing the sublimation transfer paper; preferably according to claim 1, comprising the steps of:
providing the fibrous substrate,
applying a layer of printable transfer layer coating comprising a polyurethane emulsion to at least one side of the fibrous substrate, at a dry coat weight of 2 to 12 g/m²,
drying the coating.

15. The method of producing the sublimation transfer paper according to claim 14, wherein the layer of printable transfer layer coating is applied with a film press applicator, a stiff blade applicator, a bent blade applicator, a metering rod applicator, a smooth rod applicator, or a spray coating applicator.

16. (canceled)

17. The sublimation transfer paper according to claim 8, wherein the natural polysaccharide or derivative thereof has a viscosity within the range of 1.000 and 10.000 mPa-s, when measured by Brookfield viscosimetry with a number 4 spindle at 20 rpm and 20° C.

18. The sublimation transfer paper according to claim 8, wherein the natural polysaccharide or derivative thereof is obtained via a treatment with hydrolytic enzymes.

19. The sublimation transfer paper according to claim 8, wherein the natural polysaccharide or derivative thereof is a sodium salt of carboxymethylcellulose (CMC)

20. The sublimation transfer paper according to claim 8, wherein the weight ratio between the at least one polyurethane and the natural polysaccharide or derivative thereof is of from 1:10 to 5:10.

21. The sublimation transfer paper according to claim 1, wherein the fibrous substrate has a grammage comprised of from 30 to 120 g/m² or has a COBB value (20 s) comprised between 10 and 40 g/m².
